(19) United States
(12) Patent Application Publication
(10) Pub. No.: US 2022/0151251 A1
(43) Pub. Date: May 19, 2022

(54) SYSTEM FOR TREATING WHOLE MEAT MATERIAL AND GRINDING WHOLE MEAT MATERIAL INTO GROUND MEAT PRODUCT

(71) Applicant: Provisur Technologies, Inc., Chicago, IL (US)

(72) Inventors: Lowell W. Sampson, St. George, UT (US); Marshall Dean Smith, Riverton, UT (US)

(21) Appl. No.: 17/527,287

(22) Filed: Nov. 16, 2021

Related U.S. Application Data
(60) Provisional application No. 63/115,025, filed on Nov. 17, 2020.

(51) Int. Cl. A23B 4/30; A23L 13/60; A23B 4/12; A23B 4/015; A23B 4/16; A22C 17/00; A22C 17/08

(52) U.S. Cl. CPC A23B 4/30; A23L 13/60; A23B 4/12; A23V 2002/00; A23B 4/16; A22C 17/0093; A22C 17/08; A23B 4/015

(57) ABSTRACT

A system for treating whole meat material and grinding whole meat material into ground meat product includes a microbial treatment station including a hopper into which whole meat material is deposited, a conveyor which conveys the whole meat material, and a microbial intervention apparatus configured to treat the whole meat material to substantially reduce an amount of microbes on an exterior surface of a whole meat material; a grinding station including a grinder downstream of the conveyor and operatively connected to the microbial treatment station, the grinder having a orifice plate through which the whole meat material passes and is ground into ground meat product and a cavity downstream of the orifice plate which receives the ground meat product and a microbial treatment apparatus in communication with the cavity and configured to treat the ground meat product to deter growth of microbes on the ground meat product.

### CROSS-REFERENCE TO RELATED APPLICATION(S)

This application claims priority to U.S. provisional application Ser. No. 63/115,025, filed on Nov. 17, 2021, the contents of which are incorporated herein in its entirety.

### FIELD OF THE DISCLOSURE

The present disclosure relates to a system for treating whole meat material and grinding whole meat material into ground meat product.

### BACKGROUND

It is desirable to treat meat products to deter growth of microbes. Various treatments are known. One example is provided in U.S. Pat. No. 10,874,113 which uses a combination of high-pressure processing and a bacteria reducing chemical on ground meat. Another example is provided in U.S. Publication No. 2020/0337341 which uses a combination of a high pH composition and an oxidizer.

### SUMMARY

A system for treating whole meat material and grinding whole meat material into ground meat product in accordance with some example embodiments includes a microbial treatment station including a hopper into which whole meat material is deposited, a conveyor which conveys the whole meat material along a path, and a microbial intervention apparatus configured to treat the whole meat material to substantially reduce an amount of microbes on an exterior surface of a whole meat material; a. grinding station operatively connected to an output of the microbial treatment station, the grinding station including a grinder downstream of the conveyor, the grinder having a orifice plate through which the whole meat material passes and is ground into ground meat product and a cavity downstream of the orifice plate which receives the ground meat product; and a microbial treatment apparatus in communication with the cavity and configured to treat the ground meat product to deter growth of microbes on the ground meat product.

This Summary is provided merely for purposes of summarizing some example embodiments so as to provide a basic understanding of some aspects of the disclosure. Accordingly, it will be appreciated that the above described example embodiments are merely examples and should not be construed to narrow the scope or spirit of the disclosure in any way. Other embodiments, aspects, and advantages of various disclosed embodiments will become apparent from the following detailed description taken in conjunction with the accompanying drawings which illustrate, by way of example, the principles of the described embodiments.

### BRIEF DESCRIPTION OF THE DRAWINGS

The organization and manner of the structure and operation of the disclosed embodiments, together with further objects and advantages thereof, may best be understood by reference to the following description, taken in connection with the accompanying drawings, which are not necessarily drawn to scale, wherein like reference numerals identify like elements in which:

FIG. 1 depicts a side elevation view of an assembly for the treatment and grinding of whole meat material into ground meat product;

FIG. 2 depicts a perspective view of the assembly;

FIG. 3 depicts a top plan view of the assembly;

FIG. 4 depicts a top plan view of a portion of the assembly;

FIG. 5 depicts a side elevation view of a portion of the assembly;

FIG. 6 depicts a perspective view of a hopper of the assembly;

FIG. 7 depicts a perspective view of internal components of a grinding machine of the assembly;

FIG. 8 depicts a schematic representation of some of the stations of the assembly;

FIG. 9 depicts a top plan view of a conveying station of the assembly with the openable cover not shown;

FIG. 10 depicts a top plan view of a mixer/grinder station of the assembly with the openable cover not shown; and

FIG. 11 depicts a block diagram of a control system of the assembly.

### DETAILED DESCRIPTION

While the disclosure may be susceptible to embodiment in different forms, there is shown in the drawings, and herein will be described in detail, specific embodiments with the understanding that the present disclosure is to be considered an exemplification of the principles of the disclosure, and is not intended to limit the disclosure to that as illustrated and described herein. Therefore, unless otherwise noted, features disclosed herein may be combined together to form additional combinations that were not otherwise shown for purposes of brevity. It will be further appreciated that in some embodiments, one or more elements illustrated by way of example in a drawing(s) may be eliminated and/or substituted with alternative elements within the scope of the disclosure.

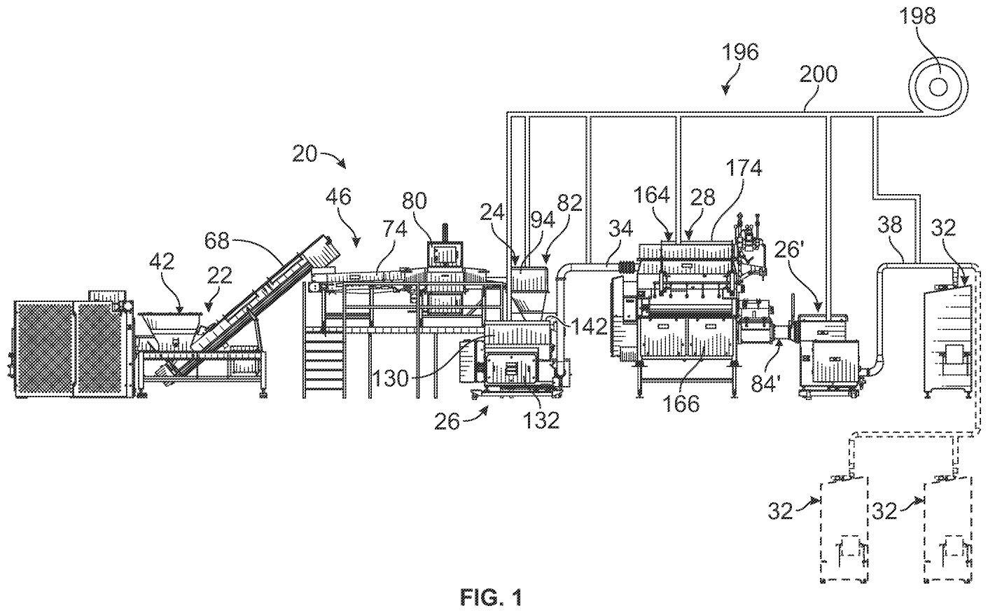

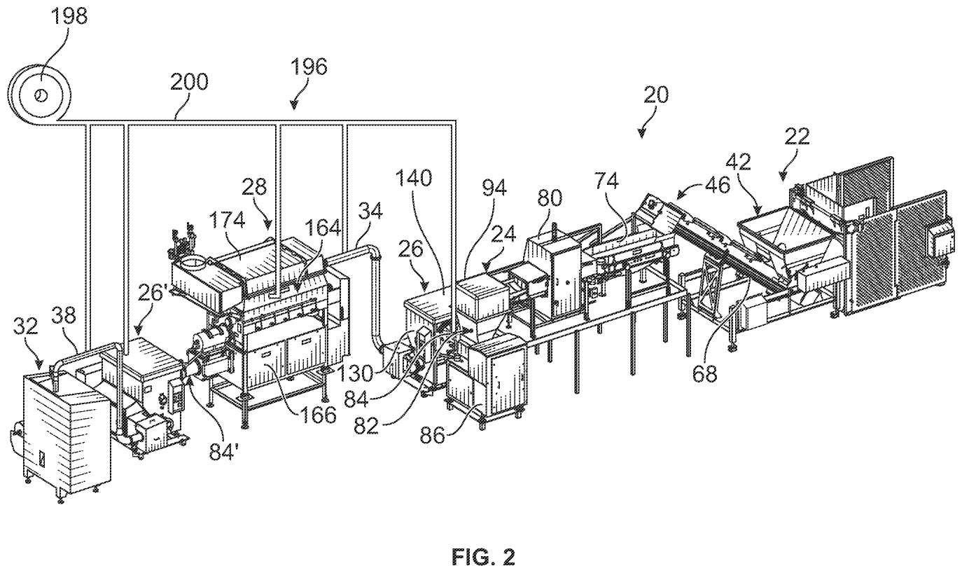

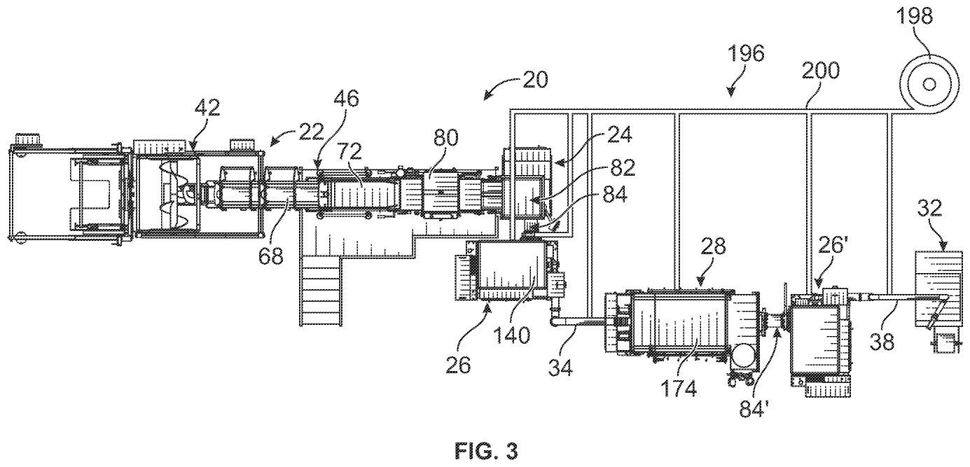

FIGS. 1-3 show an assembly 20 for the treatment and grinding of whole meat material into ground meat product. The whole meat material is whole muscle or whole trimmings of animal meat, such as beef, lamb, turkey, pork, or poultry. The assembly 20 provides an automated system which can also further process the ground meat product, such as being formed into patties by a food patty molding machine, such as that disclosed in U.S. Pat. No. 9,545,113 or 9,955,719.

The assembly 20 includes a microbial treatment station 22, a grinding station 24 downstream of the microbial treatment station 22, and a conveying station 26 downstream of the grinding station 24. In some embodiments and as shown, the assembly 20 further includes a mixer/grinder station 28 downstream of the conveying station 26, and a second conveying station 26′ downstream of the mixer/grinder station 28 as shown in FIG. 1. In some embodiments and as shown, the assembly 20 further includes a further processing station 32 which may be a chub packaging system, a forming machine, a sizing machine, etc. As shown, the conveying station 26 is connected to the mixer station or the mixer/grinder station 28 by a pipe 34 having passageway 36 therethrough, and the second conveying station 26′ is connected to the further processing station 32 by a pipe 38 having passageway 40 therethrough. The conveying station 26, the pipe 34, the mixer/grinder station 28, the second conveying station 26′, the pipe 38, and the further processing station 32 are completely sealed from atmosphere such that outside atmosphere cannot enter therein.

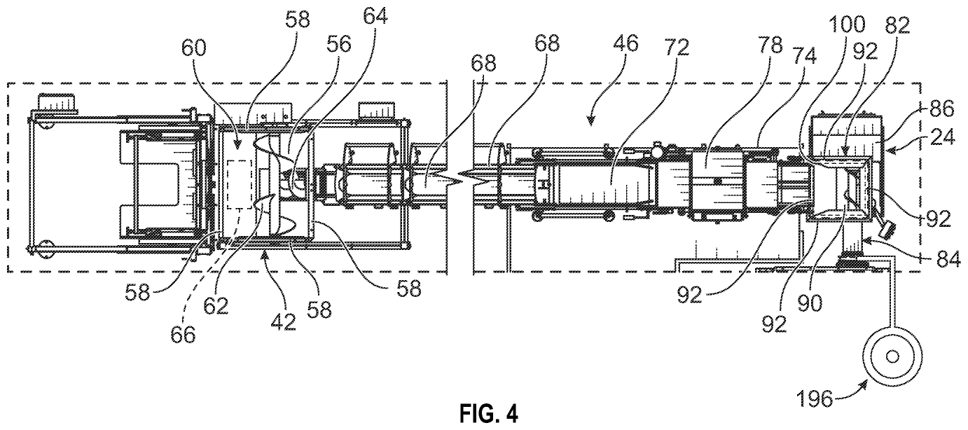

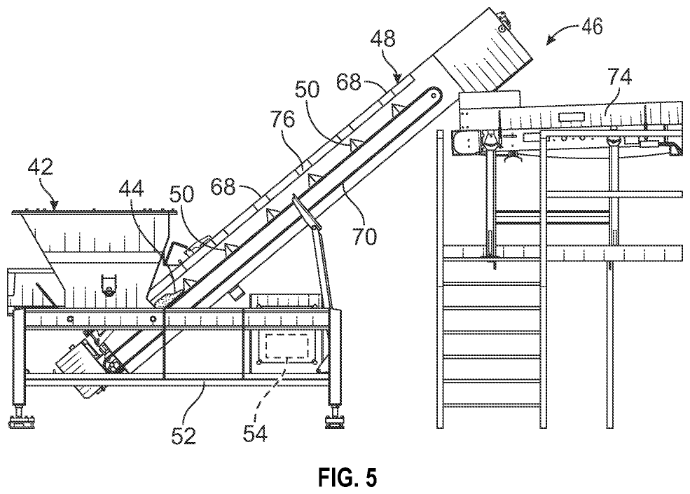

The microbial treatment station 22, see FIGS. 4 and 5, includes a hopper 42 into which the whole meat material 44 is deposited, a conveyor apparatus 46 which transports the whole meat material 44 from the hopper 42 to the grinding station 24, and a microbial intervention apparatus 48, see FIG. 5. The microbial intervention apparatus 48 causes antimicrobial agent 50 to come into contact with an exterior surface of the whole meat material 44 which substantially reduces an amount of microbes on the exterior surface of the whole meat material 44 prior to grinding.

The hopper 42 is mounted on a base 52 that houses a driving assembly 54 for actuating the components of the microbial treatment station 22. The hopper 42 has a bottom wall 56, and front, rear and side walls 58 extending upwardly therefrom and which forms a receiving cavity 60 into which the whole meat material 44 is placed. In an embodiment, the upper end of the hopper 42 is open. The hopper 42 may have augers 62, 64 at the bottom thereof which moves the whole meat material 44 to the conveyor apparatus 46. The hopper 42 may have a weighing device 78, see FIG. 4, which weighs the whole meat material 44 within the receiving cavity 60 of the hopper 42. Suitable weighing devices 66 include, but are not limited to, a load cell provided under the hopper 42.

The conveyor apparatus 46 includes an inclined pipe 68 which has a driven endless conveyor belt 70 therein that is used to transport the whole meat material 44. In the embodiment as shown, the conveyor apparatus 46 further includes one or more driven endless conveyor belts 72 provided in an open topped frame 74 which receives the whole meat material 44 from the inclined pipe 68 and transports the whole meat material 44 to the grinding station 24.

In an embodiment, the antimicrobial agent 50 of the microbial intervention apparatus 48 is an antimicrobial solution which is deposited onto the exterior surface of the whole meat material 44 as the whole meat material 44 travels along the inclined conveyor belt 70 in the inclined pipe 68. In an embodiment, the microbial intervention apparatus 48 includes at least one sprayer 76 within the pipe 68 which dispenses the antimicrobial solution onto the exterior surface of the whole meat material 44. In an embodiment, the sprayers 76 are located on the upper internal surface of the pipe 68. In another embodiment, the antimicrobial agent 50 of the microbial intervention apparatus 48 is provided by the hopper 42 being filled with antimicrobial solution through which the whole meat material 44 passes and may be completely submerged, such that the whole meat material 44 passes through a bath of the antimicrobial agent 50. The hopper 42 has suitable fill ports and drain ports to provide for the antimicrobial agent 50 to be changed in the hopper 42. Alternatively, the sprayers 76 are provided in the hopper 42 and the antimicrobial agent 50 in the form of an antimicrobial solution sprayed on the exterior surface of the whole meat material 44. Suitable antimicrobial solutions include, but are not limited to, alcohols and organic acids such as lactic acid, citric, acetic, peroxyacetic. In yet another embodiment, the antimicrobial agent 50 of the microbial intervention apparatus 48 is light, such as ultraviolet light, emitted from illuminations devices 76 which irradiate the exterior surface of whole meat material 44. In this embodiment, the illuminations devices 76 may be within the inclined pipe 68 or within the hopper 42. Other means for substantially reducing the amount of microbes on the exterior surface of the whole meat material 44 are known and are within the scope of the present disclosure. In other embodiments, combinations of sprayers, illuminations devices, etc., can be included in the microbial intervention apparatus 48.

The frame 74 supporting the one or more conveyor belts 72 is open from above and moves the treated whole meat material 44 to the grinding station 24. The open topped frame 74 allows an operator to visually inspect the treated whole meat material 44. In some embodiments, an X-ray device 80, FIG. 4, is provided along the one or more conveyor belts 72 which images the treated whole meat material 44 to detect foreign objects and/or lean point(s) in the treated whole meat material 44.

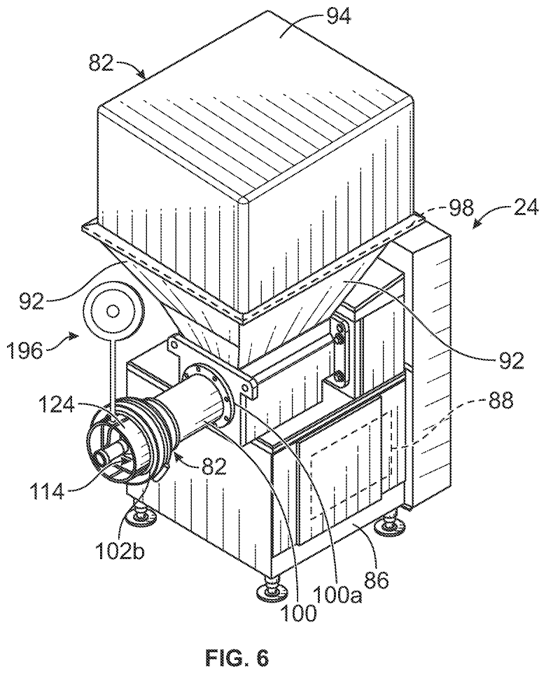

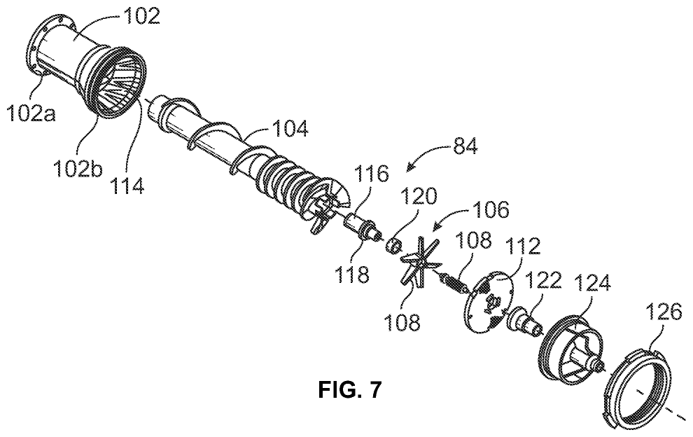

The grinding station 24, see FIGS. 4, 6 and 7, receives the treated whole meat material 44 from the microbial treatment station 22 and grinds the treated whole meat material 44 into ground meat product. The grinding station 24 includes a hopper 82 which receives the treated whole meat material 44 from the one or more conveyor belts 72, a grinding machine 84 which receives the treated whole meat material 44 from the hopper 82 and grinds the treated whole meat material 44 into ground meat product. FIGS. 6 and 7 illustrate an exemplary grinding station 24 that can be used.

The hopper 82 is mounted on a base 86 that houses a driving assembly 88 for actuating the components of the conveying station 26. The hopper 82 has a bottom wall 90, front, rear and side walls 92 extending upwardly therefrom, and an openable cover 94 closing upper ends of the walls 92. The walls 90, 92 and the cover 94 form a receiving cavity into which treated whole meat material 44 is placed prior to being ground by the grinding machine 84 (the cover 94 is not shown in FIG. 4). The walls 90, 92 and the cover 94 of the hopper 82 are sealed to each other by a seal 96. An opening 100 is provided through one of the walls 92 through which the treated whole meat material 44 enters the hopper 82 upon exiting the conveyor apparatus 46.

The grinding machine 84 includes a grinder head 102 that connects to an opening through another one of the walls 92 of the hopper 82 at end 102a thereof. The grinder head 102 has an opposing end 102b which terminates in an outlet. As best shown in FIG. 7 in the illustrated embodiment, the grinder head 102 includes a feed screw 104, a knife assembly 106 having blades 108, and an auger 110 are keyed or otherwise locked in rotational unison with each other, and an orifice plate 112 which is non-rotationally mounted within the grinder head 102 so that the treated whole meat material 44 is forced therethrough while being conveyed through the grinder head 102 by operation of the feed screw 104 to form the ground meat product. A cavity 114 is provided downstream of the orifice plate 112 within the grinder head 102. The feed screw 104 is rotationally mounted in the grinder head 102 and is arranged so that rotation of the feed screw 104 advances the treated whole meat material 44 from the hopper 82 through the grinder head 102. In an embodiment, and as described in U.S. Pat. No. 9,975,128, a center pin 116, a spacer washer and spring pack assembly 118, and a bushing 120 mount the knife assembly 106 and the auger 110 to the feed screw 104. A collection cone 122 is arranged outside of the auger 110 and abuts the orifice plate 112 so that hard materials that pass through the orifice plate 112 are directed into the collection cone 122 to appropriate discharge tube (not shown). A bridge 124 supports the collection cone 122 and a mounting ring 126 holds the bridge 124 against the orifice plate 112. While an example grinding machine 84 is shown and described, other grinding machines are within the scope of the present disclosure.

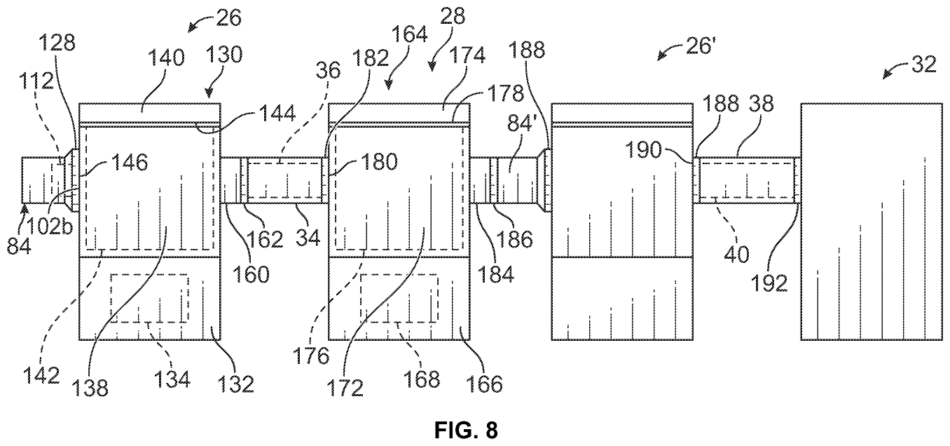

Upon exiting the grinding station 24, the ground meat product is deposited into the conveying station 26. The end 102b of the grinder head 102 is connected to an inlet of the conveying station 26 by a seal 128, see FIG. 8, to prevent the entry of atmosphere at the joint between the grinding machine 84 and the conveying station 26.

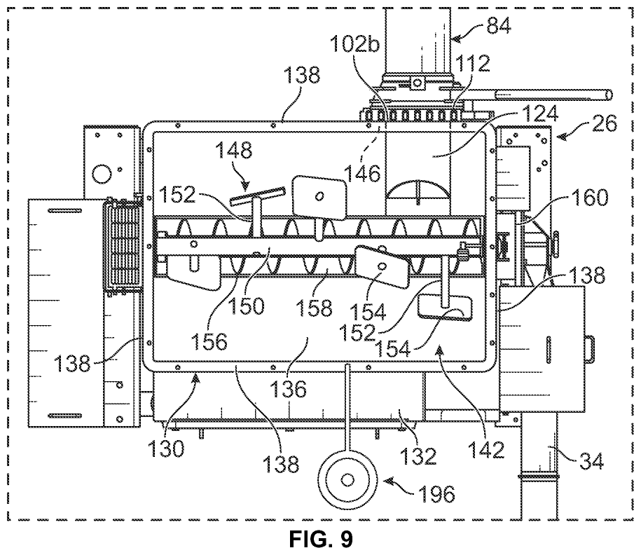

An example conveying station 26 is shown in FIGS. 1, 8 and 9. The conveying station 26 includes a hopper 130 mounted on a base 132 that houses a driving assembly 134 for actuating the components of the conveying station 26. The hopper 130 has a bottom wall 136, front, rear and side walls 138 extending upwardly therefrom, and an openable cover 140 (not shown in FIG. 9) closing upper ends of the walls 138. The walls 136, 138 and the cover 140 form a receiving cavity 142 into which the ground meat product is deposited after being ground by the grinding machine 84. The walls 136, 138 and the cover 140 are sealed to each other by a seal 144, see FIG. 8, to prevent the entry of atmosphere at the joint between the walls 136, 138 and the cover 140. An opening 146 is provided through one of the walls 138 through which the ground meat product enters the hopper 130 upon exiting the grinding machine 84. The seal 128 is provided between the end 102b of the grinder head 102 and the wall 138 of the hopper 130. A paddle assembly 148 extends between the opposite walls 138 of the hopper 130. The paddle assembly 148 has a shaft 150, which extends longitudinally generally parallel to a longitudinal axis of the hopper 130, a plurality of arms 152 extending from the shaft 150, and paddles 154 connected at the ends of the arms 152. The driving assembly 134 rotates the shaft 150 in either a clockwise or counterclockwise direction. When the paddle assembly 148 is rotated, the ground meat product is moved within the hopper 130. A driven auger 156 extends between the two of the walls 138 of the hopper 130, and is generally aligned with the longitudinal axis of the hopper 130. The auger 156 may be disposed within a trough 158 formed in the bottom wall 136 of the hopper 130. A portion of the auger 156 projects outwardly from one of the walls 138 and is housed in an auger housing 160 which is welded or otherwise sealed to the wall 138. During the conveying operation, the paddle assembly 148 and the auger 156 are continuously rotated to move the ground meat product through the hopper 130. Rotation of the auger 156 unloads the ground meat product through the trough 158, into the auger housing 160, and then into and through the passageway 36 of the pipe 34. The output of the auger housing 160 and the input of the pipe 34 are connected by a seal 162, see FIG. 8, to prevent the entry of atmosphere at the joint between the auger housing 160 and the pipe 34.

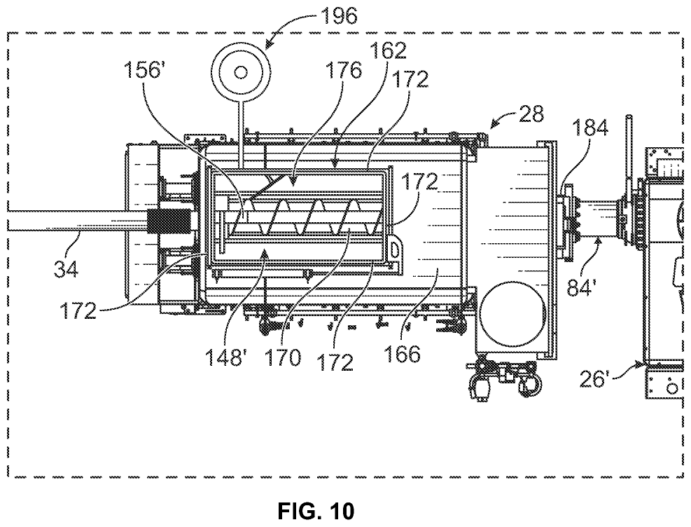

As shown, the ground meat product is then moved into the mixer/grinder station 28, FIGS. 1, 8 and 10. The mixer/grinder station 28 mixes the ground meat product to create a homogeneous meat mixture having uniform characteristics throughout and then provides a second grind. As shown, the mixer/grinder station 28 includes a hopper 164 mounted on a base 166 that houses that houses a driving assembly 168 for actuating the components of the mixer/grinder station 28. The hopper 164 has a bottom wall 170, front, rear and side walls 172 extending upwardly therefrom, and an openable cover 174 (the cover 174 is not shown in FIG. 10) closing upper ends of the walls 172. The walls 170, 172 and the cover 174 form a receiving cavity 176 into which the ground meat product is deposited from the passageway 36 of the pipe 34. The walls 170, 172 and the cover 174 of the hopper 164 are sealed to each other by a seal 178, see FIG. 8, to prevent the entry of atmosphere at the joint between the walls 170, 172 and the cover 174. An opening 182 is provided through the wall 172 through which the ground meat product enters the hopper 164 upon exiting an output of the pipe 34. A seal 184 is provided between the pipe 34 and the hopper 164, see FIG. 8, to prevent the entry of atmosphere at the joint between the pipe 34 and the hopper 164. Paddle assemblies 148′, like paddle assemblies 148 described hereinabove, extend between opposite walls 172 of the hopper 164. The specifics of the paddle assemblies 148′ are not repeated herein. A driven auger 156′, like auger 156 described hereinabove, extends between opposite walls 172, and is generally aligned with the longitudinal axis of the hopper 164. The specifics of the driven auger 156′ are not repeated herein.

During the mixing operation, the paddle assemblies 148′ are continuously rotated to move the ground meat product through the hopper 164. Simultaneously, the auger 156′ is rotated to move the ground meat product through the hopper 164 in the opposite direction. This action provides a back and forth action for the ground meat product, to provide a uniform mix. After the mixing operation is completed, the direction of rotation of the paddle assemblies 148′ and the auger 156′ are complementary so as to move the mixed ground meat product toward the same wall 138. A portion of the auger 156′ projects outwardly from one of the walls 172 and is housed in an auger housing 186 which is welded or otherwise sealed to the wall 172. During the conveying operation, the paddle assembly 148′ and the auger 156′ are continuously rotated to move the mixed ground meat product through the hopper 164. Rotation of the auger 156′ unloads the ground meat product into the auger housing 186 and into a second grinding machine 84′ which may take the same form as grinding machine 84 such that the specifics are not repeated herein. The output of the auger housing 186 and the input of the grinding machine 84 are connected by a seal 188, see FIG. 8, to prevent the entry of atmosphere at the joint between the auger housing 186 and the grinding machine 84. Alternatively, the grinding machine 84 can be eliminated and replaced with a pipe (not shown) such that this station 28 only provides a mixing action. The seal 188 would then be provided at the output of the auger housing 186 and the pipe.

As shown, the output of the second grinding machine 84′ is connected to the second conveying station 26′, which may take the same form as conveying station 26 such that the specifics are not repeated herein. The output of the second grinding machine 84′ (or the pipe if the second grinding machine 84′ is not provided) and the second conveying station 26′ are connected by a seal 190, see FIG. 8, to prevent the entry of atmosphere at the joint between the second grinding machine 84′ (or the pipe if the second grinding machine 84′ is not provided) and the second conveying station 26′. The specifics of this second conveying station 26′ are not repeated herein.

As shown in the illustrated embodiment, the ground meat product is then discharged through the passageway 40 of the pipe 38 into various further processing stations 32 for forming, shaping, or packaging the product. The input of the passageway 40 of the pipe 38 is sealed to an opening of the second conveying station 26′ by a seal 190, and the output the passageway 40 of the pipe 38 is sealed to an opening of the further processing station 32 by a seal 192. Seal 190 is shown in FIG. 8 and prevents the entry of atmosphere at the joint between the pipe 38 and the second conveying station 26′. Seal 192 is shown in FIG. 8 and prevents the entry of atmosphere at the joint between the pipe 38 and the further processing station 32. The machinery depicted in FIGS. 1-3 is a known chub packaging system.

The seals 144, 178 of the hoppers 130, 164 and the seals 128, 162, 184, 188, 190, 192 provided between mated components seal the stations 26, 28, 26′, 32 and the pipes 34, 38 from atmosphere. The seals 144, 178 of the hoppers 130, 164 may be formed of an elastomeric material. The seals 128, 162, 184, 188, 190, 192 are formed of a suitable material such as an elastomeric material, for example urethane. Alternatively, instead of providing separate seals 128, 162, 184, 188, 153, 190, 192, the components can be welded together to prevent the entrance of atmosphere at the joints.

The cavity 114 of the grinding station 24, the receiving cavities 142, 176 of the hoppers 130, 164 and the passageways 36, 40 of the pipes 34, 38 have a microbial treatment apparatus 196 which deters the growth of microbes on the ground meat product.

In an embodiment, the microbial treatment apparatus 196 deters the growth of microbes on the ground meat product by modifying the atmosphere through which the ground meat product travels. As the treated whole meat material 44 is being ground by the grinding machine 84 into the ground meat product, the treated whole meat material 44 provides an air blockage downstream of the orifice plate 112. The cavity 114 downstream of the orifice plate 112 is sealed from upstream components of the assembly 20 by the treated whole meat material 44 being ground. Since the amount of microbes on the surface of the treated whole meat material 44 has been substantially reduced prior to grinding, and the microbial treatment apparatus 196 deters growth of microbes on the ground meat product after grinding, and the ground meat product is substantially free of contaminants after processing by the assembly 20.

In an embodiment, the microbial treatment apparatus 196 is provided by one or more pumps 198 connected either directly to or indirectly to each of the cavities 114, 142, 176 and the passageways 36, 40 by one or more pipes 200. In an embodiment, the oxygen is removed from the cavities 114, 142, 176 and the passageways 36, 40 by the one or more pumps 198, and another gas or gas mixture is injected into the cavities 114, 142, 176 and the passageways 36, 40 by the one or more pumps 198. The injected gas or gas mixture promotes the shelf life of the resulting product. An example of a suitable gas or gas mixtures is a non-oxygen gas, for example, carbon dioxide gas, nitrogen gas, a reduced oxygen gas mixture. The reduced oxygen mixture may have 10% oxygen or less, may have 5% oxygen or less, and may have 1% oxygen, and may be mixed with another gas, such as nitrogen. In an embodiment, oxygen is removed from the cavities 114, 142, 176 and the passageways 36, 40 by the one or more pumps 198, and liquid that controls the temperature to an optimal level is injected into the cavities 114, 142, 176 and the passageways 36, 40 by the one or more pumps 198. An example of a suitable liquid is liquid carbon dioxide or liquid nitrogen. In another embodiment, a controllable vacuum is applied to the cavities 114, 142, 176 and the passageways 36, 40 by the one or more pumps 198 to cause evacuation of air within the cavities 114, 142, 176 and the passageways 36, 40. In another embodiment, a positive pressure is provided in each of the cavities 114, 142, 176 and the passageways 36, 40 by the one or more pumps 198.

In another embodiment, the microbial treatment apparatus 196 deters the growth of microbes on the ground meat product by causing antimicrobial agent to come into contact with the ground meat product. In an embodiment, the antimicrobial agent of the microbial treatment apparatus 196 is an antimicrobial solution which is deposited onto the ground meat product as the ground meat product is being processed downstream of the orifice plate 112. This antimicrobial solution may be deposited by sprayers which dispense the antimicrobial solution onto the ground meat product as it is being processed downstream of the orifice plate 112. Suitable antimicrobial solutions include, but are not limited to, alcohols and organic acids such as lactic acid, citric, acetic, peroxyacetic. In yet another embodiment, the antimicrobial agent of the microbial treatment apparatus 196 is light, such as ultraviolet light, emitted from illumination devices which irradiate the ground meat product as it is being processed downstream of the orifice plate 112. Other means for deterring the growth of the microbes on the ground meat are known and are within the scope of the present disclosure. In other embodiments, combinations of sprayers, illuminations devices, etc., can be included in the microbial treatment apparatus 196.

In other embodiments, combinations of one or more of the above microbial treatment apparatuses 196 can be provided.

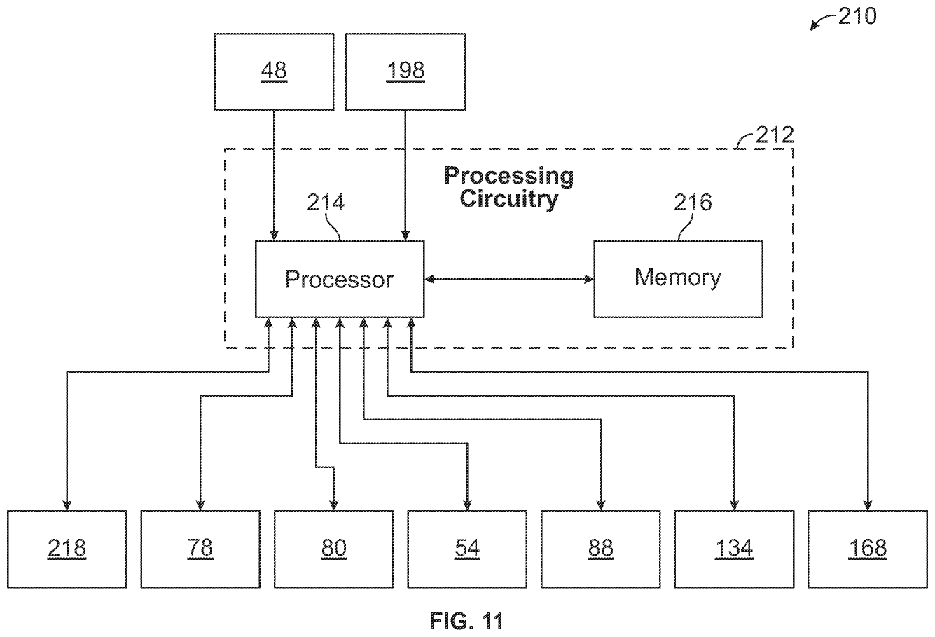

The operation of the assembly 20 is controlled by a control system 210 which is illustrated in block diagram in FIG. 11. In this regard, when implemented on the assembly 20, control system 210 energizes and controls operation of the moving components of the assembly 20. It will be appreciated that the components, devices or elements illustrated in and described with respect to FIG. 11 below may not be mandatory and thus some may be omitted in certain embodiments. Additionally, some embodiments may include further or different components, devices or elements beyond those illustrated in and described with respect to FIG. 11.

In some example embodiments, the control system 210 may include processing circuitry 212 that is configurable to perform actions in accordance with one or more example embodiments disclosed herein. In this regard, the processing circuitry 212 may be configured to perform and/or control performance of one or more functionalities of the assembly 20, in accordance with various example embodiments. The processing circuitry 212 may be configured to perform data processing, application execution and/or other processing and management services according to one or more example embodiments. In embodiments in which the driven components include an on-board motor controller, the processing circuitry 212 may comprise the on-board motor controller(s) and/or may be communicatively coupled with the on-board motor controller(s) to enable the processing circuitry 212 to communicate with and control operation of the assembly 20, in accordance with various example embodiments.

In some embodiments, the control system 210 or a portion(s) or component(s) thereof, such as the processing circuitry 212, may include one or more chipsets and/or other components that may be provided by integrated circuits.

In some example embodiments, the processing circuitry 212 may include a processor 214 and, in some embodiments, such as that illustrated in FIG. 11, may further include memory 216. The processor 214 may be embodied in a variety of forms. For example, the processor 214 may be embodied as various hardware-based processing means such as a microprocessor, a coprocessor, a controller or various other computing or processing devices including integrated circuits such as, for example, an ASIC (application specific integrated circuit), an FPGA (field programmable gate array), some combination thereof, or the like. Although illustrated as a single processor, it will be appreciated that the processor 214 may comprise a plurality of processors. The plurality of processors may be in operative communication with each other and may be collectively configured to perform one or more functionalities of the assembly 20 as described herein. For example, in some embodiments in which the processor 214 comprises a plurality of processors, the plurality of processors may comprise one or more on-board motor controllers. In some example embodiments, the processor 214 may be configured to execute instructions that may be stored in the memory 216 or that may be otherwise accessible to the processor 214. As such, whether configured by hardware or by a combination of hardware and software, the processor 214 is capable of performing operations according to various embodiments while configured accordingly. In some example embodiments, the memory 216 may include one or more memory devices. Memory 216 may include fixed and/or removable memory devices. In some embodiments, the memory 216 may provide a non-transitory, computer-readable storage medium that may store computer program instructions that may be executed by the processor 214. In this regard, the memory 216 may be configured to store information, data, applications, instructions and/or the like for enabling the assembly 20 to carry out various functions in accordance with one or more example embodiments.

In some embodiments, the processor 214 is in communication with one or more of the driving assemblies 54, 88, 134, 168 for causing actuation of the components of the microbial treatment station 22, of the components of the conveying station 26, of the components of the conveying station 26 (and/or conveying station 26′), and/or of the components of the mixer/grinder station 28. The further processing station 32 also has a driving assembly (not shown) which may be in communication with the processor 214. The driving assemblies 54, 88, 134, 168, and the driving assembly of the further processing station 32, may be embodied as various means, such as circuitry, hardware, a computer program product comprising a computer readable medium (for example, the memory 216) storing computer readable program instructions that are executable by a processing device (for example, the processor 214), or some combination thereof. In some embodiments, the processor 214 (or the processing circuitry 212) may include, or otherwise control the driving assemblies 54, 88, 134, 168, and the driving assembly of the further processing station 32.

The processor 214 further is in communication with the microbial intervention apparatus 48 and the microbial treatment apparatus 196 for causing actuation of the components of the microbial intervention apparatus 48 and the microbial treatment apparatus 196.

The weighing device 78 is in communication with the processor 214. The amount of antimicrobial agent 50 to be applied on the whole meat material 44 can be determined in a variety of manners. In some embodiments, information from the weighing device 78 is communicated to the control system 210 and the processor 214 uses this information to determine the amount of antimicrobial agent 50 to be applied on a given amount of whole meat material 44.

In an embodiment, a user interface 218 may be provided and is in communication with the processor 214 and/or memory 216, and/or driving assemblies 54, 88, 134, 168, and the driving assembly of the further processing station 32. The operator may input information regarding the whole meat material 44, or regarding parameters on the grinding, the mixing etc. performed by the assembly 20. The user interface 218 may include any user interface element that may enable an operator to input information. By way of non-limiting example, the user interface 218 may include one or more buttons, one or more switches, a keypad/keyboard, a display, a touch screen display, some combination thereof, or the like. The driving assemblies 54, 88, 134, 168, and the driving assembly of the further processing station 32, may be configured to access (e.g., from memory 216) a table or other structure which stores various profiles based on parameters. In an embodiment, the operator inputs information regarding the whole meat material 44 and the processor 214 uses this information to determine the amount of antimicrobial agent 50 to be applied on a given amount of whole meat material 44.

In some embodiments, a set amount of antimicrobial agent 50 is always applied by the control system 210 to each whole meat material 44 being processed.

The X-ray device 80 is in communication with the processor 214. When a foreign object is detected by the X-ray device 80 in the treated whole meat material 44, further action can be taken, such as the control system 210 indicating to the operator that the treated whole meat material 44 is not suitable for further processing and is to be discarded.

As an example, the grinder of U.S. Pat. No. 9,975,128, which disclosure is herein incorporated by reference to the extent is it not contrary to the present disclosure, can be used as the grinding station in the present disclosure with at least the exception being that the hopper has the cover so as to partially seal the hopper. As an example, the mixer of U.S. Pat. No. 4,844,619, which disclosure is herein incorporated by reference to the extent is it not contrary to the present disclosure, can be used as the mixing station in the present disclosure with at least the exception being that the hopper has the cover so as to seal the hopper.

Many modifications and other embodiments of the disclosure set forth herein will come to mind to one skilled in the art to which these disclosed embodiments pertain having the benefit of the teachings presented in the foregoing descriptions and the associated drawings. Therefore, it is to be understood that the disclosure is not to be limited to the specific embodiments disclosed herein and that modifications and other embodiments are intended to be included within the scope of the disclosure. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the disclosure. In this regard, for example, different combinations of elements and/or functions than those explicitly described above are also contemplated within the scope of the disclosure. Although specific terms are employed herein, they are used in a generic and descriptive sense only and not for purposes of limitation.

While particular embodiments are illustrated in and described with respect to the drawings, it is envisioned that those skilled in the art may devise various modifications without departing from the spirit and scope of the appended claims. It will therefore be appreciated that the scope of the disclosure and the appended claims is not limited to the specific embodiments illustrated in and discussed with respect to the drawings and that modifications and other embodiments are intended to be included within the scope of the disclosure and appended drawings. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the disclosure and the appended claims.

What is claimed is:

1. An assembly configured for turning whole meat material into ground meat product, the assembly comprising:
a microbial treatment station including a hopper into which whole meat material is deposited, a conveyor which conveys the whole meat material along a path, and a microbial intervention apparatus configured to treat the whole meat material to substantially reduce an amount of microbes on an exterior surface of a whole meat material;
a grinding station operatively connected to an output of the microbial treatment station, the grinding station including a grinder downstream of the conveyor, the grinder having an orifice plate through which the whole meat material passes and is ground into ground meat product and a cavity downstream of the orifice plate which receives the ground meat product; and
a microbial treatment apparatus in communication with the cavity and configured to treat the ground meat product to deter growth of microbes on the ground meat product.

2. The assembly of claim 1, wherein the microbial intervention apparatus deposits an antimicrobial agent on an exterior surface of the whole meat material.

3. The assembly of claim 2, wherein the antimicrobial agent is an acid.

4. The assembly of claim 3, wherein the antimicrobial agent is sprayed within at least one of the hopper and the conveyor by at least one sprayer.

5. The assembly of claim 2, wherein the antimicrobial agent is ultraviolet light.

6. The assembly of claim 1, wherein the microbial intervention apparatus is provided by a bath of antimicrobial agent through which the whole meat material is moved.

7. The assembly of claim 1, wherein the microbial treatment apparatus modifies an atmosphere of the cavity.

8. The assembly of claim 7, wherein the atmosphere is modified by removing oxygen from the cavity.

9. The assembly of claim 7, wherein the atmosphere is modified by providing positive pressure in the cavity.

10. The assembly of claim 7, wherein the atmosphere is modified by a vacuum which forms a vacuum in the cavity.

11. The assembly of claim 7, wherein the atmosphere is modified by a one or more pumps that removes oxygen from the cavity and injects a non-oxygen gas or reduced oxygen gas into the cavity that promotes shelf life of a meat product.

12. The assembly of claim 11, wherein the non-oxygen gas is carbon dioxide gas.

13. The assembly of claim 11, wherein the non-oxygen gas is nitrogen.

14. The assembly of claim 11, wherein the reduced oxygen gas has 10% or less oxygen.

15. The assembly of claim 7, wherein the microbial intervention apparatus deposits an antimicrobial agent on an exterior surface of the whole meat material.

16. The assembly of claim 1, wherein the microbial treatment apparatus deposits an antimicrobial agent on the ground meat product.

17. The assembly of claim 16, wherein the antimicrobial agent is an acid.

18. The assembly of claim 16, wherein the antimicrobial agent is ultraviolet light.

19. The assembly of claim 16, wherein the microbial intervention apparatus deposits an antimicrobial agent on an exterior surface of the whole meat material.

20. The assembly of claim 1, further comprising an X-ray provided along the conveyor.
